(19) United States
(12) Patent Application Publication
(10) Pub. No.: US 2017/0008246 A1
(43) Pub. Date: Jan. 12, 2017

(54) METHOD AND EQUIPMENT FOR CONTROL AND MANUFACTURE OF CORRUGATED CARDBOARD

(71) Applicant: VALMET AUTOMATION OY, Espoo (FI)

(72) Inventors: Markku MÄNTYLÄ, Kangasala (FI); Mikko LASSILA, Mutala (FI); Mikko TALONEN, Ikaalinen (FI); Kari SÖDER, Tampere (FI); Marko TOSKALA, Orivesi (FI)

(73) Assignee: VALMET AUTOMATION OY, Espoo (FI)

(21) Appl. No.: 15/122,002

(22) PCT Filed: Feb. 26, 2015
(86) PCT No.: PCT/FI2015/050113

§ 371 Date: Aug. 26, 2016

(30) Foreign Application Priority Data
Feb. 28, 2014 (FI) 20145194

(51) Int. Cl. B31F 1/28

(52) U.S. Cl. CPC B31F 1/2831; B31F 1/285

(57) ABSTRACT

Equipment for controlling manufacture of corrugated cardboard, including: a sensor arrangement arranged to measure moisture of a liner in connection with unwinding of the liner in an unwinding part in order to control the moisture of the liner prior to gluing to a fluting on the basis of the measured moisture.

### FIELD

The invention relates to a method and equipment for control and manufacture of corrugated cardboard.

### BACKGROUND

Corrugated cardboard is widely used as packaging material in transport packages, consumer packages and wraps, for instance. Corrugated cardboard includes at least one corrugated fluting layer and at least one flat surface paper or liner. Often, one fluting is glued between two liners. In order to improve strength and resistance, corrugated cardboard may even be provided with a plurality of fluted layers. The glue used is usually starch glue but, for humid conditions, wet-strength glue may also be used.

It is important for the quality of corrugated cardboard that the gluing is strong and the surfaces of the cardboards do not warp. Drawbacks exist in the management of manufacture of corrugated cardboards, which impairs the quality of corrugated cardboards. Therefore, a need exists to improve the manufacture of corrugated cardboard.

### BRIEF DESCRIPTION

An object of the invention is to provide an improved solution for the manufacture of corrugated cardboard. This is achieved by control equipment according to claim 1.

The invention also relates to manufacturing equipment according to claim 6.

The invention also relates to a control method according to claim 7.

The invention also relates to a manufacturing method according to claim 11.

The invention also relates to a process controller according to claim 12.

Preferred embodiments of the invention are disclosed in the dependent claims.

The equipment and method according to the invention provide several advantages. In the manufacture of single-faced corrugated cardboard, the moisture of the liner may be controlled already while manufacturing the corrugated cardboard, which reduces or eliminates warping in the finished corrugated cardboard.

### LIST OF FIGURES

The invention is now described in closer detail in connection with the preferred embodiments and with reference to the accompanying drawings, in which

FIG. 1 shows an example of equipment for manufacture of corrugated cardboard;

FIG. 2 shows an example of equipment for manufacture of single-faced corrugated cardboard;

FIG. 3A shows an example of uncontrolled behaviour of moisture in the equipment for manufacture of single-faced corrugated cardboard;

FIG. 3B shows an example of uncontrolled and controlled behaviour of moisture in the equipment for manufacture of single-faced corrugated cardboard;

FIG. 4 shows an example of scanning measurement;

FIG. 5 shows an example of in-line measurement,

FIG. 6 shows an example of a processor and memory; and

FIG. 7 shows an exemplary flow chart of a control method.

### DESCRIPTION OF EMBODIMENTS

The following embodiments are presented by way of example. Even though the description may refer to “an” embodiment or embodiments at different points, this does not necessarily mean that each such reference refers to the same embodiment or embodiments or that the feature only applies to one embodiment. Individual features of different embodiments may also be combined in order to enable other embodiments.

FIG. 1 shows an example of corrugated cardboard equipment. A starting end of the process is provided with at least one unwinder or splicer 10 at which paper rolls 12 are unwound and forwarded towards fluting and gluing. The paper is usually about 2.5 m in width. In order to manufacture a fluting, the paper is corrugated by a corrugator or singlelacer 14 at which the liner is also glued to the fluting. This is how single-faced corrugated cardboard is made. At a glue machine 16, a second liner is glued to the fluting of the single-faced corrugated cardboard in order to produce double-faced corrugated cardboard. Next, the double-faced corrugated cardboard is heated on a grate 18 for drying the glue. Also multilayer corrugated cardboards may be manufactured in a similar manner. An emptying paper roll 12 may be replaced by a new paper roll 12, in which case an end of the exhausting paper may be glued to an end of the unfolding paper. Since a corrugated cardboard machine is used for manufacturing differently sized batches of different cardboards, a paper roll may be replaced every fifteen minutes, for instance. The manufacture of double-faced corrugated cardboard necessitates paper from three rolls, which further makes paper roll replacement more frequent in the manufacture of corrugated cardboard.

The fluting of corrugated cardboard may be provided with a plurality of different flute profiles. With the microwave G&N paper, the thickness or flute height of the corrugated cardboard is about 0.8 mm and the flute number is about 550 flutes per metre. With the microwave F paper, the thickness of the corrugated cardboard is about 1.0 mm and the flute number is about 440 flutes per metre. With the microwave E paper, the thickness of the corrugated cardboard is about 1.5 mm and the flute number is about 350 flutes per metre. With the fine flute B paper, the thickness of the corrugated cardboard is about 3 mm and the flute number is about 150 flutes per metre. With the coarse flute C paper, the thickness of the corrugated cardboard is about 4 mm and the flute number is about 130 flutes per metre. With the double-flute BC paper, the thickness of the corrugated cardboard is about 7 mm.

The fluting may be manufactured from primary fibre for instance in a semi-chemical process, and its basis weight may be 80 g/m² to 200 g/m². Recycled Fluting, RF, may on one hand also be partly or completely manufactured from recycled fibres. It is possible to use in corrugated cardboard for instance three kinds of liners: kraftliner, euroliner and testliner. Kraft-liners are mostly made from primary fibre and the kraftliners are suitable for food packages. The basis weight may be 60 g/m² to 400 g/m² or even more than 400 g/m². Euroliners are made from recycled paper. Testliners are mainly made from recycled fibre. In connection with the manufacture of corrugated cardboard, instead of papers, terms such as carton i.e. corrugated carton and surface carton may also be used.

The quality of the corrugated cardboard obtained as an end product is affected by the qualities and characteristics of the papers used, as well as the gluing. Most often paper rolls are stored in outdoor storages where temperature and moisture vary constantly. Therefore, the moisture and temperature levels of papers on the rolls vary according to the weather and, consequently, differ from the driving moisture on the paper machine. In addition, the moisture and temperature of the paper is also affected by whether the moisture and temperature of the paper is examined at the outermost circumferences, inner circumferences, edge or middle of the roll. In particular, upon replacing the roll, the moisture level may change greatly abruptly. The temperature may also change drastically. Such changes in moisture cause warping or curling (warb, curl) of papers and corrugated cardboards obtained as end products, which impedes the manufacture of corrugated cardboard and folding and assembly of a package from corrugated cardboard. Also temperature may affect warping of the corrugated cardboard in a similar manner.

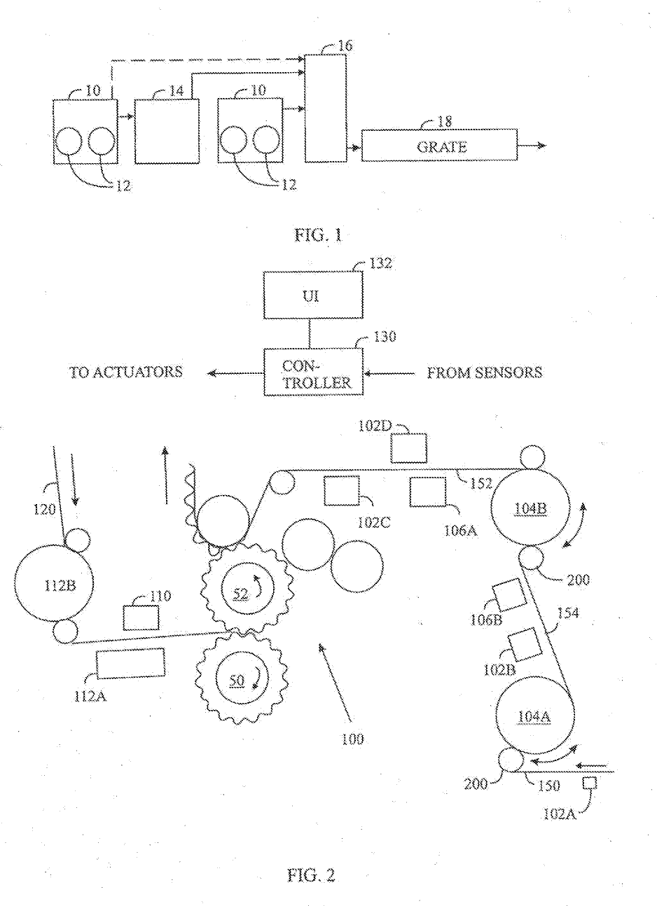

FIG. 2 shows corrugated cardboard manufacturing equipment for manufacture of single-faced corrugated cardboard. The equipment of FIG. 2 thus corresponds to the corrugator 14 of FIG. 1. An unwound fluting 120 enters actuators 112A, 112B at which the fluting 120 is pre-treated for corrugation. Then, fluting rollers 50, 52 form the corrugated fluting 120. Next, the fluting 120 advances to the glue machine 16 at which glue is dispensed to flute peaks of the fluting 120 and the fluting 120 is glued to a liner 150. The control equipment comprises a sensor arrangement 102A, 102B, 102C, 102D, 102D. The control equipment may further comprise a set of actuators 104A, 104B, 106A, 106B. The control equipment comprises one or more control devices. The sensor 102A of the sensor arrangement may be located in connection with unwinding in an unwinding part 10.

Further, the equipment for manufacture and/or control of corrugated cardboard may in an embodiment comprise a controller 130 and a user interface 132. The controller 130 may comprise at least one processor and one or more memories provided with a computer program code. The computer program code may by means of said at least processor and said at least one or more memories cause the equipment for control and/or manufacture of corrugated cardboard to operate in a desired manner.

The sensor arrangement 102A, 102B, 102C, 102D measures the moisture of the liner 150 that is to be unwound and that has moved from storage to the unwinding part 10 in connection with the unwinding of the liner 150 in the unwinding part 10. In such a case, a set of heaters 104A, 104B stabilizes the moisture of the liner 150 on the basis of the measured moisture prior to gluing in a gluing unit 100 to the fluting 120. The sensor arrangement 102A, 102B, 102C, 102D performs the measurement in connection with the unwinding before the liner 150 has had the time to advance from the unwinding 10 to a control procedure carried out by the set of actuators 104A, 104B, 106A, 106B. Upon stabilizing the moisture of the liner 150, the moisture of the liner 150 is controlled. Excessive moisture of the liner 150 exceeding a desired amount of moisture is reduced by heating the liner 150. The heating power is a function of moisture such that the more excessive moisture present in the liner 150, the higher the power with which the liner 150 is heated. If, again, no excessive moisture is present in the liner 150, the liner 150 is not heated. The power of the set of heaters 104A, 1046 may thus vary as the liner advances in the machine direction. The set of heaters 104A, 104B may also be used for stabilizing transverse moisture of the liner 150 by controlling the heating power in accordance with the transverse moisture measured in the transverse direction. This enables, in a manner which saves the process resources, the liner 150 to be provided with a uniform moisture, which reduces warping in the finished cardboards.

The set of actuators 104A, 104B, 106A, 106B, which comprises at least one actuator, in one embodiment comprises a set of heaters 104A, 106B. In one embodiment, the set of actuators comprises a set of moistening devices 106A, 1066. In one embodiment, the set of actuators comprises a set of heaters 106A, 106B and a set of moistening devices 106A, 106B. In an embodiment, the set of actuators 104A, 104B, 106A, 106B saves, on the basis of the measurement carried out by the sensor arrangement 102A, 102B, 102C, 102D, the moisture in the liner 150 which keeps on advancing towards being glued to the fluting 120 in the gluing unit 100.

In an embodiment, the sensor arrangement 102A, 102B, 102C, 102D may measure the moisture of the liner 150 between the gluing unit 100 and the actuator 106A closest to the gluing unit 100 and in the process direction before the gluing unit 100. This makes it possible to obtain information on the liner 150 in connection with the unwinding and just before gluing. In such a case, it is possible to optimise the operation of actuators before gluing so that the moisture of the liner 150 can be stabilized efficiently during its use and/or in connection with replacing the liner rolls.

In an embodiment, the machine speed of the manufacturing equipment may be changed on the basis of the measurement carried out by the sensor arrangement 102A, 102B, 102C, 102D. In an embodiment, the machine speed may be slowed down when the moisture of the liner 150 increases. In an embodiment, the machine speed may be increased when the moisture of the liner 150 increases. The moisture may then be the overall moisture or the moisture of one of the surfaces 152, 154.

The fluting 120 may also be measured in a corresponding manner by means of one or more sensors 110. Correspondingly, the moisture and/or temperature of the fluting 120 may be controlled by means of one or more actuators 112A, 1126. Such controls may be carried out after unwinding, prior to fluting and gluing.

In an embodiment, the sensor arrangement 102A, 102B, 102C, 102D may be used for measuring the liner 150 for surface moisture. The measurement may be performed on one side or on both sides. In an embodiment, the sensor arrangement 102A, 102B, 102C, 102D is used for measuring the liner 150 for moisture in the direction of travel of the liner 150 prior to the actuator 104A, 104B, 106A, 106B and after the actuator 104A, 104B, 106A, 106B. This enables the set of actuators 104A, 104B, 106A, 106B to be used for quickly changing the control of the moisture and optionally also temperature of the liner 150.

In an embodiment, the heater 104B is located in the direction of travel of the liner 150, just before the gluing unit 100. This means that the effect of heating has no time to change on the way to gluing.

In an embodiment, the moistening device 106A is located in the direction of travel of the liner 150, just before the gluing unit 100. This means that the effect of moistening has no time to change on the way to gluing.

In an embodiment, the sensor arrangement 102A, 102B, 102C, 102D carries out the measurement of moisture optically. In an embodiment, the sensor arrangement 102A, 102B, 102C, 102D measures the liner 150 at one or more wavelengths where water has absorption greater than the surrounding wavelengths. In an embodiment, the absorption wavelength of water may be for instance about 1.4 μm, 1.9 μm and/or 2.7 μm. In an embodiment, moisture measurement is performed on the liner 150 as reflection measurement. The penetration depth into the liner 150 of optical radiation from such optical reflection measurement may correspond to approximately half the thickness of the liner 150, in which case the optical measurement may be used for measuring the surface moisture of the liner 150. The intensity and wavelength of the optical radiation may be adjusted to the characteristics of the liner so as to enable successful surface moisture measurement. The adjustment may be based on theory, simulation or testing.

In an embodiment, moisture is measured as relative moisture with respect to cellulose or the basis weight of the liner 150. This enables moisture information to be obtained as percentage of moisture, for instance. The sensor arrangement 102A, 102B, 102C, 102D may further be used for measuring the amount of cellulose in the liner 150, for instance.

In an embodiment, in addition to surface moisture, it is possible to measure the overall moisture of the liner 150. In an embodiment, such overall moisture measurement is performed on the liner 150 as measurement through the liner.

In an embodiment, the moisture measurement enables the moisture distribution and/or gradient in a thickness direction of the liner 150 to be determined. The determination of the moisture distribution and/or gradient may be carried out by measuring the surface moisture on both sides of the liner 150. The determination of the moisture distribution and/or gradient may be carried out by measuring the surface moisture on at least one side of the liner 150 and the overall moisture of the liner 150.

In an embodiment, the set of actuators 104A, 104B, 106A, 106B may be used for controlling the moisture distribution and/or gradient in the thickness direction of the liner 150 on the basis of the moisture measurement. This makes it possible to manage the warping and/or gluing of the corrugated cardboard and produce an optimised end product.

In an embodiment, the moisture of different surfaces is stabilized by means of the set of actuators 104A, 1046, 106A, 1066 on the basis of moisture measurement. Moisture may be stabilized to reside within a desired range. This, too, reduces the warping of the corrugated cardboard and/or facilitates the gluing so as to produce an optimised end product.

In an embodiment, different liners 150 are controlled to have different stabilized moisture levels by means of the set of actuators 104A, 1046, 106A, 1066 on the basis of moisture measurement.

In an embodiment, different kinds of liners 150 are controlled to have different stabilized moisture levels by means of the set of actuators 104A, 104B, 106A, 106B on the basis of moisture measurement. In such a case, the moisture of a kraftliner, for instance, may be stabilized at a moisture level different than that of a testliner. Other characteristics of the liner 150 may also affect the stabilization of the moisture level. The characteristics may include for instance the basis weight, porosity, coarseness, surface smoothness, surface roughness.

In an embodiment, the moisture levels between the liners 150 of the liner rolls are stabilized when a liner for at least one surface 152, 154 is changed. In an embodiment, the moisture levels of the liners 150 of the liner rolls are stabilized on a first side 152, which is a side to be glued. In an embodiment, the moisture levels of the liners 150 of the liner rolls are stabilized on a second side 154, which is a side opposite the side to be glued.

The fluting 120 may also be measured in a similar manner optically by means of one or more sensors 110.

The set of heaters 104A, 104B controls the temperature of the liner 150 on the basis of the measurement carried out by the sensor arrangement 102A, 102B, 102C, 102D. The set of heaters 104A, 104B may heat the liner 150 on the side of at least one surface 152, 154 in order to stabilize the moisture in the machine direction of the liner 150. If the moisture level is high, the set of heaters 104A, 1046 may be used for reducing the moisture.

In addition, the set of moistening devices 106A, 106B controls the moisture of the liner 150 on the basis of the measurement carried out by the sensor arrangement 102A, 102B, 102C, 102D. The set of moistening devices 106A, 106B may moisten the liner 150 on the side of at least one surface 152, 154 in order to stabilize the moisture in the machine direction of the liner 150. If the moisture level is low, the set of heaters 104A, 104B may be used for increasing the moisture.

Correspondingly, the moisture of the fluting 120 may be controlled by means of a steam box or another moistening device, for instance, as the actuator 112A. For controlling the temperature, in turn, a steam cylinder or another heater with an adjustable contact angle, for instance, may be used as the actuator 112B.

The gluing unit 100 glues the liner 150, subject to heat and/or moisture control, and the fluting 120 together.

In an embodiment, the set of heaters 104A, 104B comprises at least one drying cylinder, such a set of heaters being shown in FIG. 2. In such a case, the temperature of the liner 150 may be controlled by changing the contact angle of the drying cylinder on the basis of the measurement carried out by the sensor arrangement 102A, 102B, 102C, 102D. The contact angle may be changed by moving a roll 200, in which case the surface area of the liner 150 against the drying cylinder grows or increases (curved arrow next to the heaters 104A and 104B). The longer the contact angle, the more the drying cylinder heats the liner 150. The heat of the drying cylinder is derived from hot steam contained in the drying cylinder.

In an embodiment, the set of heaters 104A, 104B comprises an infrared heater (not shown in the figures) which controls its heating power on the basis of the measurement carried out by the sensor arrangement 102A, 102B, 102C, 102D.

In an embodiment, the set of heaters 104A, 104B comprises an induction heater (not shown in the figures) which controls its heating power on the basis of the measurement carried out by the sensor arrangement 102A, 102B, 102C, 102D.

In an embodiment, said set of moistening devices 106A, 106B comprises a steam box (not shown in the figures) which controls the amount of steam it applies to the liner 150. In an embodiment, the steam box controls the temperature of steam it applies to the liner 150.

In an embodiment, the set of moistening devices 106A, 106B comprises a set of water nozzles (not shown in the figures) which controls the volume of water jet it applies to the liner 150. In an embodiment, the set of water nozzles comprises a water temperature control part (not shown in the figures) which controls the temperature of water jet applied to the liner 150.

In an embodiment, the sensor arrangement 102A, 102B, 102C, 102D also measures the liner 150 for temperature. In such a case, the set of heaters 104A, 104B may control the temperature of the liner 150 on the basis of the surface moisture measurement and the temperature. Correspondingly, the set of moistening devices 106A, 106B may control the moisture of the liner 150 on the basis of the surface moisture measurement and the temperature.

In an embodiment, the set of moistening devices 106A, 106B controls the moisture of the first surface 152 of the liner 150 on the basis of the measurement carried out by the sensor arrangement 102A, 102B, 102C, 102D. In such a case, the set of heaters 104A, 104B controls the temperature of the second surface 154 of the liner 150 on the basis of the measurement carried out by the sensor arrangement 102A, 102B, 102C, 102D.

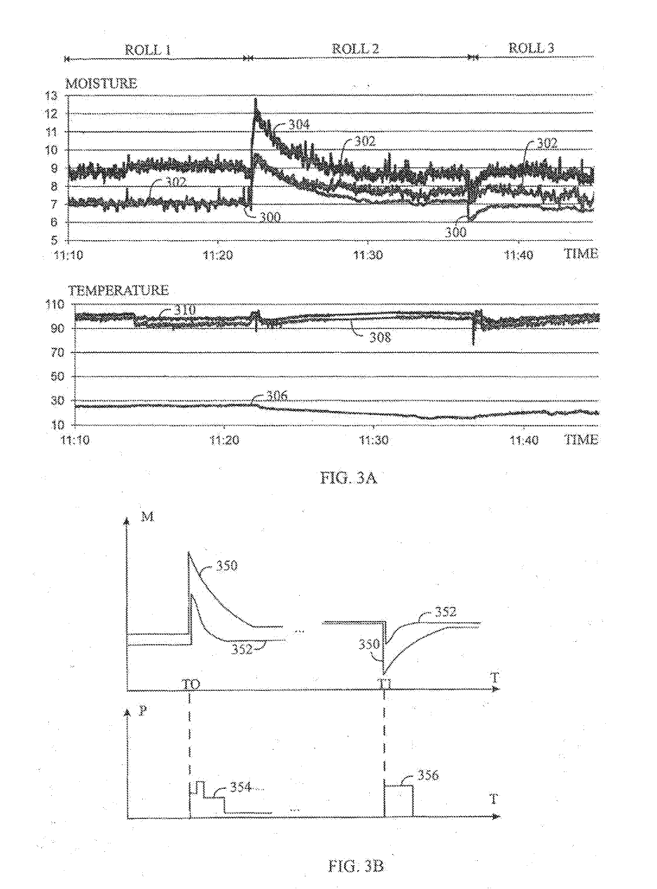

FIG. 3A shows a change in moisture and temperature as a function of time upon replacement of three different paper rolls 12 during the manufacture of corrugated cardboard. Moisture is given in percentages while time is given in hours and minutes. Temperature is given in degrees Celsius, while time is given in hours and minutes on the same scale as moisture, temperature and moisture being measured simultaneously. Graph 300 shows the moisture of an unwound paper roll. Graph 302 shows the surface moisture of the liner 150 on the first surface 152, which is glued to the fluting 120. Graph 304 shows the surface moisture of the liner 150 on the second surface 154, which may be a glueless outer surface of the corrugated cardboard.

Graph 306 shows the temperature of an unwound paper roll. Graph 308 shows the surface temperature of the liner 150 on the first surface 152 to be glued to the fluting 120. Graph 310 shows the surface moisture of the liner 150 on the second surface 154, which may be the glueless outer surface of the corrugated cardboard. The graphs show that when a paper roll 1 is replaced by another roll 2, the temperature slightly rises temporarily, whereas when the roll 2 is replaced by a roll 3, the temperature drops slightly. If the moisture of the liner 150 were controlled on the basis of the temperature only, the heating of the liner 150 would be turned down on account of the rise in temperature. This control would, however, be made in the wrong direction since according to the moisture measurement, the liner 150 from the roll 2 is much moister than the liner 150 from the roll 1. Thus, even if the temperature of the liner 150 does rise upon replacing the rolls, the liner 150 actually has to be heated more in order to correct the surface moisture and/or the overall moisture. Correspondingly, when replacing the roll 2 by the roll 3, on the basis of temperature the heating would be turned up, even if according to the surface moisture measurement the heating should be turned down. FIG. 3A also shows that moisture measurements performed on the different surfaces 152, 154 of the liner 150 enable a moisture difference between the surfaces to be determined, which indicates the moisture distribution in the thickness direction of the liner. The moisture distribution and/or moisture gradient enable(s) the moisture and/or overall moisture of the different surfaces of the liner 150 to be controlled.

Changes in temperature and surface moisture take place inside a single paper roll as well. It is also in such a situation possible to change the surface moisture of the liner 150 by means of surface moisture measurement.

On the basis of FIG. 3A, it can be concluded that the stabilization of the temperature of the liner is not essential as far as the control of surface moisture is concerned, but the temperature can be allowed to vary. In such a case, it is possible to control the overall moisture and/or surface moisture of the liner 150 more efficiently.

FIG. 3B shows the measured moisture M of the liner 150 as a function of time T on a freely selected scale, and the operating power P of an actuator as a function of time T on a freely selected scale. Moisture M may refer to surface moisture on either surface of the liner 150. The measurement may have been carried out by a sensor arrangement 102A, 102B, 102C, 102D. In this case, it can be considered that the measurement has been carried out by the sensor arrangement 102B or 102C. In the case according to graph 350, the liner 150 is not moistened nor heated. In the case according to graph 352, the liner is moistened and heated. The moisture of the liner 150 is quite uniform at first. At time T0, the liner roll is replaced, and the moisture of the liner of a second roll, particularly at first, is clearly higher than that of the liner of the previous roll. After a while, the moisture of the second liner evens out but, in this example, remains slightly different than the moisture of the first roll. At time T1, another liner replacement takes place. Then, the moisture of a third liner is at first clearly lower than that of the second liner. At this time, too, the moisture evens out after a while.

Graph 352 shows a corresponding moisture measurement but now the heater 104A, 104B is turned on or its power is turned up at time T0, according to graph 354. The heating power may also be increased shortly before time T0, when the moisture change is just about to arrive at the gluing unit 100, or shortly after time T0, when the moisture change is still great and has an effect on the manufacture of corrugated cardboard. The heating power may be increased and decreased during the change in the heating power. It can be seen in graph 352 that even if the moisture change in the case according to graph 352 is not exactly as great as in the case of graph 350, the duration of the moisture change may be shortened by heating. Correspondingly, if heating is started already before a moisture change, the extent of the moisture change may also be diminished. On the other hand, it is also possible to intensify the increase of moisture and/or extend the duration of the moisture change by turning the heating down.

In the case according to graph 352, it is possible at time T1 to increase the moistening of the liner according to graph 356, in which case the moisture change of the third liner is temporally shorter than in the unmoistened case according to graph 350. Moistening may be increased and decreased stepwise, just like heating. The moistening may be increased shortly before time T1, when the moisture change is just about to arrive at the gluing unit 100, or after time T1, when the moisture change in the liner is still great and has an effect on the manufacture of corrugated cardboard.

In an embodiment, the sensor arrangement 102A, 1026, 102C, 102D may be used for measuring the porosity H, thickness P, smoothness S and/or roughness Ka of the liner 150. These measurements enable the actuator arrangement 104A, 1046, 106A, 1066 to control the moisture of the first surface 152 and/or the second surface 154 of the liner 150. For instance, as the thickness of the liner 150 grows, the moistening may be increased. The amount A of the moisture needed in the control may be determined by a function A=f(K1, K2, Ko, L1, L2, H, P, S, Ka), where K1 is the moisture of the first surface, K2 is the moisture of the second surface, Ko is the overall moisture, L1 is the moisture of the first surface, L2 is the moisture of the second surface, and f is a linear or non-linear function.

In an embodiment, in addition to the machine direction, the surface moisture of the liner 150 may be measured by the sensor arrangement 102A, 102B, 102C, 102D in the transverse direction as well. In such a case, the surface moisture of each transverse point or zone of the liner 150 may be measured and controlled separately. In an embodiment, shown in FIG. 4, the sensor arrangement 102A, 102B, 102C, 102D may scan over the liner 150. In an embodiment, shown in FIG. 5, the sensor arrangement 102A, 102B, 102C, 102D comprises a line of sensors 500 directed over the liner 150 in the transverse direction. This enables moisture and/or heat to be measured.

In an embodiment, in addition to the machine direction, the moisture of the liner 150 may be controlled by the set of moistening devices 106A, 106B in the transverse direction as well. In an embodiment, the set of moistening devices 106A, 106B may scan over the liner 150 in a manner similar to that of the sensor arrangement 102A, 102B, 102C, 102D in FIG. 4. In an embodiment, the set of moistening devices 106A, 106B comprises a line of sensors in a manner similar to that in the sensor arrangement 102A, 102B, 102C, 102D in FIG. 5, directed over the liner 150 in the transverse direction.

In an embodiment, in addition to the machine direction, the moisture of the liner 150 may be controlled by the set of heaters 104A, 1046 in the transverse direction as well. In an embodiment, the set of heaters 104A, 104B may scan over the liner 150 in a manner similar to that in the sensor arrangement 102A, 102B, 102C, 102D in FIG. 4. In an embodiment, the set of heaters 104A, 104B comprises a line of sensors in a manner similar to that in the sensor arrangement 102A, 102B, 102C, 102D in FIG. 5, directed over the liner 150 in the transverse direction.

In an embodiment, in addition to the machine direction, the heat of the liner 150 may be controlled by the set of heaters 104A, 1046 in the transverse direction as well. In such a case, the heating is directed at the liner 150 zone by zone by means of linear heating in a manner similar to the measurements of the sensor arrangement in FIG. 5.

When treating the liner 150 in terms of moisture and heat, it is possible to affect the warping of the corrugated cardboard already while manufacturing the fluting, thus resulting in an end product as desired. In such a case, the liner 150 may be curled or flattened by increasing or decreasing moisture on one side or both sides of the liner 150. By controlling the amount of moisture on the surfaces of the liner 150, the liner 150 may be curled or flattened as desired. The fluting 120 may also be treated in a similar manner.

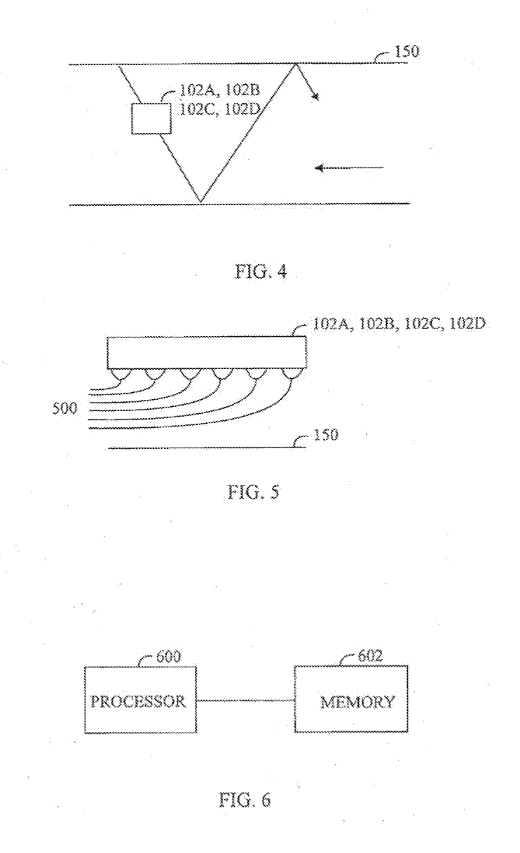

FIG. 6 shows an example of a controller 130. The controller 130 may comprise at least one processor 600 and at least one memory 602 containing a computer program code. Said at least one memory 602 together with said at least one processor and computer program code causes the controller 130 to receive surface moisture of the liner 150 measured by the sensor arrangement 102A, 102B, 102C, 102D and to control the set of actuators 104A, 104B, 106A, 106B to control the moisture of the liner 150.

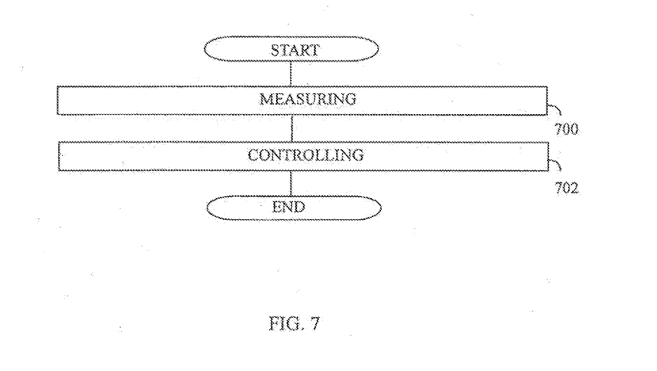

FIG. 7 is a flow chart of a control method. In step 700. In step 702, the sensor arrangement 102A, 102B, 102C, 102D is used for measuring the moisture of the liner 150 is connection with unwinding in the unwinding part 10 in order to control the moisture of the liner 150 prior to gluing to the fluting 120 on the basis of the measured moisture.

The method shown in FIG. 7 may be implemented as a logic circuit solution or computer program. The computer program may be placed on a computer program distribution means for the distribution thereof. The computer program distribution means is readable with a data processing device, and it may encode the computer program commands to control the operation of the measuring device.

The distribution means, in turn, may be a solution known per se for distributing a computer program, for instance a data processor-readable medium, a program storage medium, a data processor-readable memory, a data processor-readable software distribution package, or a data processor-readable compressed software package. In some cases, the distribution medium may also be a data processor-readable signal, or a data processor-readable telecommunications signal.

Even though the invention has been described above with reference to the examples according to the accompanying drawings, it is clear that the invention is not restricted thereto but may be modified in many ways within the scope of the accompanying claims.

1. Equipment for controlling manufacture of corrugated cardboard, the control equipment comprising a set of heaters and a sensor arrangement arranged to measure moisture of a liner that is to be unwound and that has moved from storage to an unwinding part in connection with the unwinding of the liner in order to control the moisture of the liner prior to gluing to a fluting by controlling the heating power of the set of heaters on the basis of the measured moisture.

2. The equipment for controlling manufacture of corrugated cardboard as claimed in claim 1, wherein the control equipment comprises a set of actuators arranged, on the basis of the measurement carried out by the sensor arrangement, to control moisture in said liner which keeps on advancing towards being glued to the fluting.

3. The equipment for controlling manufacture of corrugated cardboard as claimed in claim 1, wherein the sensor arrangement is arranged to measure the moisture in said liner between the gluing of the fluting and the liner and an actuator closest to the gluing and in a process direction before the gluing.

4. The equipment for controlling manufacture of corrugated cardboard as claimed in claim 1, wherein the set of actuators comprises at least one set of moistening devices arranged to control the moisture of the liner on the basis of the measurement carried out by the sensor arrangement.

5. The equipment for controlling manufacture of corrugated cardboard as claimed in claim 1, wherein the sensor arrangement is arranged to measure said liner for temperature as well;
said set of heaters is arranged to control the heat of the liner on the basis of the surface moisture measurement and the temperature; and
said set of moistening devices is arranged to control the moisture of the liner on the basis of the surface moisture measurement and the temperature.

6. Equipment for manufacturing corrugated cardboard, the manufacturing equipment comprising an unwinding part, a sensor arrangement, a set of heaters and a gluing unit;
said sensor arrangement is arranged to measure moisture of a liner that is to be unwound and that has moved from storage to the unwinding part in connection with the unwinding of the liner in the unwinding part
said set of heaters is arranged, on the basis of the measurement carried out by the sensor arrangement, to control the moisture of the liner in a direction of advancement of the process, prior to the gluing unit; and
the gluing unit is arranged to glue the liner, subject to control by the set of actuators, and a fluting together.

7. A method of controlling manufacture of corrugated cardboard, the method comprising:
measuring by a sensor arrangement moisture of a liner that is to be unwound and that has moved from storage to an unwinding part in connection with the unwinding of the liner in the unwinding part in order to control the moisture of the liner by means of a set of heaters prior to gluing to a fluting on the basis of the measured moisture.

8. The method of controlling manufacture of corrugated cardboard as claimed in claim 7, further comprising controlling by a set of actuators moisture in the liner which keeps on advancing towards being glued to the fluting.

9. The method for controlling manufacture of corrugated cardboard as claimed in claim 7, further comprising controlling by a set of moistening devices the moisture of the liner on the basis of the measurement carried out by the sensor arrangement.

10. The method for controlling manufacture of corrugated cardboard as claimed in claim 7, further comprising measuring by the sensor arrangement the liner for temperature as well; and controlling by said set of actuators the heat of the liner on the basis of the surface moisture measurement and the temperature.

11. A method of manufacturing corrugated cardboard, the method comprising:
measuring by a sensor arrangement moisture of a liner that is to be unwound and that has moved from storage to an unwinding part in connection with the unwinding of the liner in the unwinding part;
controlling by a set of heaters the moisture of the liner prior to gluing to a fluting on the basis of the measured moisture; and
gluing at a gluing unit the liner, subject to control by an actuator, and the fluting together.

12. A process controller arranged to control manufacture of corrugated cardboard and comprising
at least one processor; and
at least one memory containing a computer program code,
said at least one memory together with said at least one processor and computer program code being adapted to cause the controller to:
receive by a sensor arrangement moisture of a liner that is to be unwound and that has moved from storage to an unwinding part, measured in the unwinding part in connection with the unwinding; and
control a set of heaters to control the moisture of the liner in a direction of advancement of the process prior to gluing of the liner to a fluting.

13. A computer-readable computer program distribution means, wherein commands of the computer program are coded on the distribution means in order to execute the computer program code of claim 12.
